(19) United States
(12) Patent Application Publication
(10) Pub. No.: US 2017/0300402 A1
(43) Pub. Date: Oct. 19, 2017

(54) MOCK SERVER AND EXTENSIONS FOR APPLICATION TESTING

(71) Applicant: SAP SE, Walldorf (DE)

(72) Inventors: Andreas Hoffner, Ostringen (DE); Marcel Waechter, Graben-Neudorf (DE)

(21) Appl. No.: 15/132,841

(22) Filed: Apr. 19, 2016

(51) Int. Cl. G06F 11/36

(52) U.S. Cl. CPC G06F 11/3664; G06F 11/3612

(57) ABSTRACT

Techniques are described for employ a mock server that executes on a client to facilitate negative testing of an application and/or other types of testing. The mock server may intercept OData requests sent from an application toward a backend server. For at least some of the intercepted requests, the mock server may determine a mock response to be returned to the application instead of a response that would be generated by the backend server. In some examples, the mock server may employ various mock server extension components to generate the mock response. The mock response may include an error message, warning message, and/or other content, and may be provided to enable negative testing of the application. In some instances, the application employs a user interface (UI) model to provide UI elements.

### BACKGROUND

An organization that develops software typically tests the software prior to its release as a commercial or internally released product or service. Such testing may include functional testing to determine whether the software operates as designed or includes bugs that may be addressed. Testing may also include performance testing to determine whether the executing software performs within an appropriate range with respect to various technical parameters. For example, performance testing may determine whether executing software uses, within an acceptable range of parameters, active memory, storage space, processing capacity, network bandwidth, and/or other resources available on a computing system. In some instances, testing may include usability and/or user experience testing. Such testing may determine the extent to which the software provides a user experience that is positive or negative for end-users. For example, such testing may identify aspects of the software's user interface that are confusing or frustrating for end-users, and may identify aspects that are to be recoded and/or redesigned prior to release of the software to the general public. Other types of testing may also be performed, such as unit testing, integration testing, build testing, and so forth.

### SUMMARY

Implementations of the present disclosure are generally directed to application testing using a mock server and/or extensions to a mock server. More specifically, implementations are directed to generating mock response(s) to request(s) sent from an application, mock response(s) simulating error, warning, and/or success response(s) that may otherwise be sent by a backend in response to the request(s).

In general, innovative aspects of the subject matter described in this specification can be embodied in methods that include actions of: intercepting a request sent from an application toward a backend device, the application employing a user interface (UI) model to provide one or more UI elements; determining a mock response to the request, the mock response including at least one of an error message or a warning message; and providing the mock response to the application during negative testing to monitor behavior of the application receiving the mock response.

Implementations can optionally include one or more of the following features: determining the mock response further includes determining a status description for the request, and based at least partly on the status description, including the error message or the warning message in the mock response; the status description is provided through one or more mock server extension interfaces that include one or more of an application programming interface (API) or a UI presented with the application; the actions further include based at least partly on the status description, retriggering the request to cause a response to be generated and sent by the UI model; the actions further include incorporating the warning message into the response to generate the mock response; determining the mock response further includes determining that the request corresponds to information stored in a file and, in response, generating the mock response to include the information in the file; the file is a JavaScript Object Notation (JSON) file; the information includes at least one of a Uniform Resource Identifier (URI) or a URI pattern matching a URI included in the request; and/or the request is an OData request.

Other implementations of any of the above aspects include corresponding systems, apparatus, and computer programs that are configured to perform the actions of the methods, encoded on computer storage devices. The present disclosure also provides a computer-readable storage medium coupled to one or more processors and having instructions stored thereon which, when executed by the one or more processors, cause the one or more processors to perform operations in accordance with implementations of the methods provided herein. The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

Implementations of the present disclosure provide one or more of the following advantages. Traditionally, to perform negative testing of an application that interacts with a backend service, development organizations have manually and temporarily modified the backend service to artificially generate error situations on the client side and/or to respond to a client with success or warning messages. However, such modifications are inefficient, consume a large amount of development time, and may lead to bugs if the test code for artificially generating issues is not removed prior to release. Implementations overcome such problems by employing a mock server and/or mock server extension to dynamically generate error conditions, warning conditions, and/or other conditions for testing the application. The mock server and/or mock server extension may also dynamically generate success conditions for a particular context, including additional information and/or success message(s). Moreover, because traditional methods of negative testing may involve manual modifications (e.g., recoding) of services on a backend server, such modifications may lead to greater consumption of memory, storage space, and/or processing capability on the backend. Accordingly, because implementations remove the need for such manual modifications on the backend, implementations provide for a more efficient use of memory, storage space, and/or processing capability on the backend during the testing of an application.

It is appreciated that aspects and features in accordance with the present disclosure can include any combination of the aspects and features described herein. That is, aspects and features in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example system for using a mock server and/or mock server extension to test an application, according to implementations of the present disclosure.

FIG. 2 depicts a flow diagram of an example process for using a mock server and/or mock server extension to test an application, according to implementations of the present disclosure.

FIG. 3 depicts an example application and user interface for testing an application using a mock server, according to implementations of the present disclosure.

FIG. 4 depicts an example computing system, according to implementations of the present disclosure.

### DETAILED DESCRIPTION

Implementations of the present disclosure are directed to systems, devices, methods, and computer-readable media for testing an application using a mock server. In some implementations, the mock server is configured to enable negative testing of an application by intercepting a request sent from the application toward a backend server, and incorporating error message(s) and/or warning message(s) into mock response(s) that are sent back to the application in lieu of actual response(s) from the backend server. In at least some implementations, an application model (e.g., framework) is provided to facilitate the design, development, and operation of distributed (e.g., cross-platform) software systems in which various components operate on different computing devices within a distributed computing environment. In some implementations, the application model may be a library of controls, data binding objects, and/or other types of objects that may be employed to provide functionality at the user interface (UI) and/or other layers of an application. For example, the application model may include a library of JavaScript™ objects. In a particular example, the application model may be a version of the OpenUI5 framework maintained as an open source project by SAP SETM

Using traditional systems, it may be difficult to perform (e.g., negative) testing and/or testing of end-user relevant messages of applications that employ an application model in an efficient, automated, repeatable, and/or standardized way, particularly when such messages are related to the data exchange between the client and the backend. This difficulty may affect the testability and/or automation of various errors or issues related to the communications layer, such as the layer of the application that employs a version of HyperText Transfer Protocol (HTTP) and/or other suitable communications protocols for interactions between distributed components of the application. For example, using traditional methods it may be difficult to test and/or automate authorization and authentication issues, internal server errors, resource not found issues, and so forth. It may also be difficult to test various other types of validation issues and/or semantic errors that may occur during a data exchange process. In principle, an executing application may be able to distinguish between errors of a technical nature, errors caused by validation, and/or errors in the business logic of an application, and it may be desirable that the application correctly inform the application's end-user of the source and/or nature of the error.

Further, in some instances the (e.g., wire) format used to communicate issues from the backend to the client may itself be a source of errors. Thus, in traditional systems even if a test approach is automatable on the client side it may still lack a well-defined application programming interface (API) to raise the various error, success, and/or warning messages in the appropriate target format. Traditionally, to overcome such issues development organizations have manually and temporarily modified the backend services to artificially generate error situations on the client side and/or to respond to a client with success or warning messages. However, such modifications are inefficient, consume a large amount of development time, and may lead to bugs if the test code for artificially generating issues is not removed prior to release. Accordingly, for at least the reasons given above, traditional testing methods may lead to increased total cost of deployment (TCD), risk of poor quality, risk of regressions due to the missing automation possibilities, and/or other problems in application development. Moreover, such traditional testing methods may not cover all the possible variations of errors and/or validation issues which may occur.

In the implementations described herein, a mock server executes on the client to simulate the data exchange with the backend server(s) and/or other backend component(s). The mock server may be configured to intercept, on the client, various outbound request patterns generated at the client. The mock server may respond with mocked results, e.g., without any interaction with the backend. In some instances, the request(s) and/or response(s) may be OData request(s) and/or OData response(s). Such request(s) and response(s) may be arranged according to any suitable version of the Open Data Protocol (OData). Although examples herein may describe an application that employs OData request(s) and response(s), implementations also support other suitable protocols for handling data. As described further below, implementations provide a mock server that can be used in various types of positive testing and negative testing. In some implementations, the mock server employs one or more mock server extension modules to simulate the data exchange with the backend server(s) and/or other backend component(s).

In some implementations, the mock server provides an API to simulate (e.g., mock) error, success, and/or warning messages in an automated and repeatable way. The API may be employed in scripted unit tests for test automation. In some implementations, in addition to or instead of the API, the mock server may provide an alternative entry point in the form of a user interface (UI) for ad hoc and/or in-app testing. Such a UI may enable developers, and/or other software development personnel to readily define error, warning, and/or success message scenarios for particular OData request(s) that are to be tested. For example, the UI may enable developers to define negative testing scenarios to derive automated unit tests based on the negative testing.

Both entry points (e.g., the API and UI) may offer a same or similar set of features including an option to set patterns to indicate which OData requests are to cause the mock server to generate a negative response and/or a response including error, success, and/or warning messages. The various features that enable developers to specify error, success, and/or warning messages may include the option to set field references. Such field references may be simple or complex, e.g., for nested scenarios. In some instances, the field references may include field values that cause warnings and/or errors, and/or define a message as transient. In some examples, the generation of errors, warnings, and or success messages may be based to (e.g., semantic) validation performed in the backend. For example, an entry of a delivery date that is in the past may cause an error and/or warning to be generated in the backend. A delivery date in the future may cause a success message to be generated in the backend. In some implementations, the entry points may allow HTTP status code(s) to be set for one or more responses. The translation on the response(s) to the (e.g., wire) response format may be performed by a mock server extension that translates the warning, success, and/or error messages into HTTP response headers and/or into HTTP response bodies depending on the specified scenario.

The mock server may support both positive testing and negative testing. In positive testing, an application may be checked to ensure that the application behaves as expected under normal and/or typical operating conditions, e.g., in response to valid input data. Such testing may be described as “happy path” testing. For example, to test a UI entry field that is designed to accept only integer values as input, positive testing may include entering various integer values into the field and monitoring the application's responses to such entries. In negative testing, an application may be checked to ensure that the application behaves as intended (e.g., as designed) under abnormal and/or atypical operating conditions, e.g., in response to invalid input data. Following the above example, negative testing of the UI entry field may include entering various non-integer type values into the field and monitoring the application's responses to determine whether the application provides the appropriate errors and/or warnings in response to such entries. In some instances, type safety may be ensured by a lower layer (e.g., the UI model) and the corresponding data binding may be based on metadata without any further backend interaction. As another example, a UI entry field may be associated with a stored data value that has an acceptable range of values from 0 to 10. Negative testing may verify that entry of a value outside that range (e.g., 300) causes an appropriate error to be emitted and handled properly by the front end of the application. Negative testing may also determine whether the application front end properly handles incomplete, corrupt, improperly formatted, or otherwise abnormal data received from the backend.

In some implementations, the mock server intercepts HTTP requests and/or other types of requests that are generated at the client to be sent to the backend server. A UI may be displayed to enable the user (e.g., developer, tester, etc.) to specify conditions (e.g., URI path and/or pattern) under which the mock server is to respond to the request(s) by generating mock response(s). If the user does not provide any kind of extension and/or if the user indicates through the UI that they prefer not to have the response and/or request mocked, then the client may process the request normally by sending it to the backend server. In some instances, the request may be intercepted and an extension is provided to respond with a mock error message, warning message, and/or other failure scenarios. Response mocking may also include enriching one or more responses. For example, a response may be received from the mock server and/or from the backend server and the received response may be supplemented with additional warning(s), additional error message(s), success message(s) and/or other additional content.

The mock server enables the testing of application features that communicate with a backend server, even in instances when the backend server is not present on the network, unable to communicate over a network, not connection is available, or the server is otherwise unreachable. For example, the mock server enables negative testing to ensure that the application responds appropriately when the backend server is not reachable or has shut down, or when the various server processes that would otherwise interact with the application are not executing. The mock server also enables negative testing to test for conditions when the application is requesting information (e.g., database records, documents, files, content to be presented in the application, etc.) and such information is unavailable.

In some instances, the application may run on a device that has a limited display such as a portable computing device (e.g., smartphone, tablet computer, wearable device, etc.). Implementations may enable the negative and/or positive testing of the UI elements presented in a small UI of the application. For example, implementations may enable a mock response to simulate an actual error response that would be returned from a backend server during normal (e.g., non-testing) operations of the application. The mock error message may enable testing of the application to ensure that the application correctly presents the error message, modifies the application UI appropriately in response to the error message, and/or otherwise responds appropriately to the error message, even in situations where the application is executing on a computing device with limited display size and/or other limitations.

In some examples, the user (e.g., developer, tester, etc.) may wish to test the application UI to ensure that the application responds appropriately to the entry of data into a particular data entry field. For example, the user may enter a value of “300” into a particular data entry field of the application UI, where the backend data storage field associated with the UI field is configured to accept values from 0 to 10. The mock server may intercept the request to add “300” to the backend storage field and recognize the error condition of the request (e.g., out of range). The mock server may mock a response that the backend server would normally send, and the mock server may send the mock response to the application. The user (or an automated test script) may verify that the application responds with the appropriate error message even in situations when the application is running on a device with limited display capability (e.g., a portable computing device). Automated testing may probe a range of possible inputs and/or explore the boundary cases by submitting test values for 9.9, 10.0, 10.1, and so forth, and a user or automated test process may confirm that the application responds with the appropriate error message.

Implementations also enable regression testing to verify that a particular test that failed for a previous version of the application is no longer failing for a current version of the application. Following the above example, a previous version of the application may not have responded appropriately when a value of 30 is entered in a field for which the appropriate range of values is 0 to 10. Developers may have attempted to correct the problem in a current version of the application, and regression testing may be performed to check whether the current version of the application presents the appropriate error message when the value of 30 and/or other out-of-range values are entered into the field. The regression testing may also ensure that the application responds appropriately when in-range values are entered, e.g., to check whether the bug fix introduced other problems. Through use of the mock server, implementations enable regression testing to be performed without requiring the availability of the backend server and/or other components that may interact with the application.

In another example, a user (e.g., developer, tester, etc.) may wish to test whether the application responds with the appropriate error message when the user requests to access a document and the document is currently locked (e.g., opened by another user). Traditionally, such testing may require the user to ask another user to open the document so that it is locked. Using the mock server, the user may specify that a particular mock response be sent following a request to open a document, the mock response including the error and/or warning message indicating that the document is locked or otherwise unavailable for access currently. Thus, the mock server may obviate the need for manual opening of a document simply to test that error condition. The mock server may also enable testing to ensure that an application responds appropriately to situations when the backend server is exhibiting memory problems, coding errors, network access problems, or other anomalous conditions, without requiring the backend server to be modified to create the problems to be tested at the front end. In some instances, conventional test systems may not allow testing for such memory problems, coding errors, network access problems, and/or other anomalous conditions, due to different code ownership, non-modifiable backend code, kill dev systems, or other reasons. In such instances, the mock server and/or extensions provided by the implementations described herein may enable testing where testing may not otherwise be possible using conventional test systems.

In instances where a software platform has multiple components that are configured to interact with one another during operations of the platform, it may be challenging to perform negative testing and/or other types of testing of a component when the other components are unavailable. By mocking responses instead of relying on response(s) from other component(s), implementations enable testing of a particular component to proceed even in instances when the other component(s) are unavailable.

Although examples may describe using a mock server and/or mock server extension for negative testing of an application, implementations are not so limited. Implementations also support the use of other client-side (e.g., HTTP) interception tools to intercept messages and generate mock response(s), in addition to or instead of the mock server and mock server extension module(s) described herein.

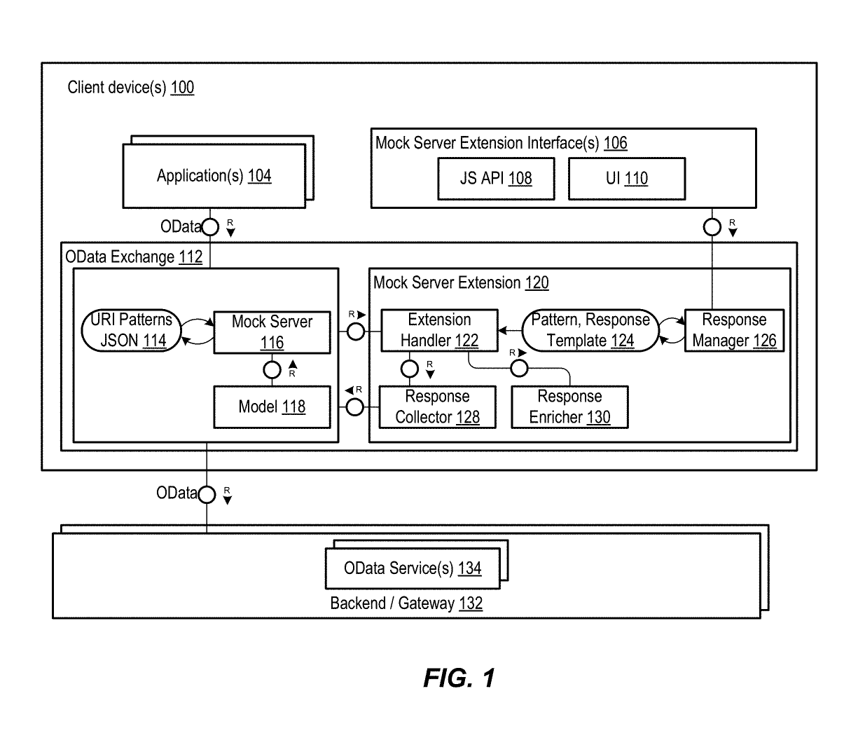

FIG. 1 depicts an example system for using a mock server to test an application, according to implementations of the present disclosure. As shown in the example of FIG. 1, the system may include one or more client devices 100. The client device(s) 100 may include any suitable number and type of computing device. Although various examples herein may describe computing device(s) as client and/or server device(s), implementations are not limited to such configurations. A particular device may operate as a client and/or server depending on the situation.

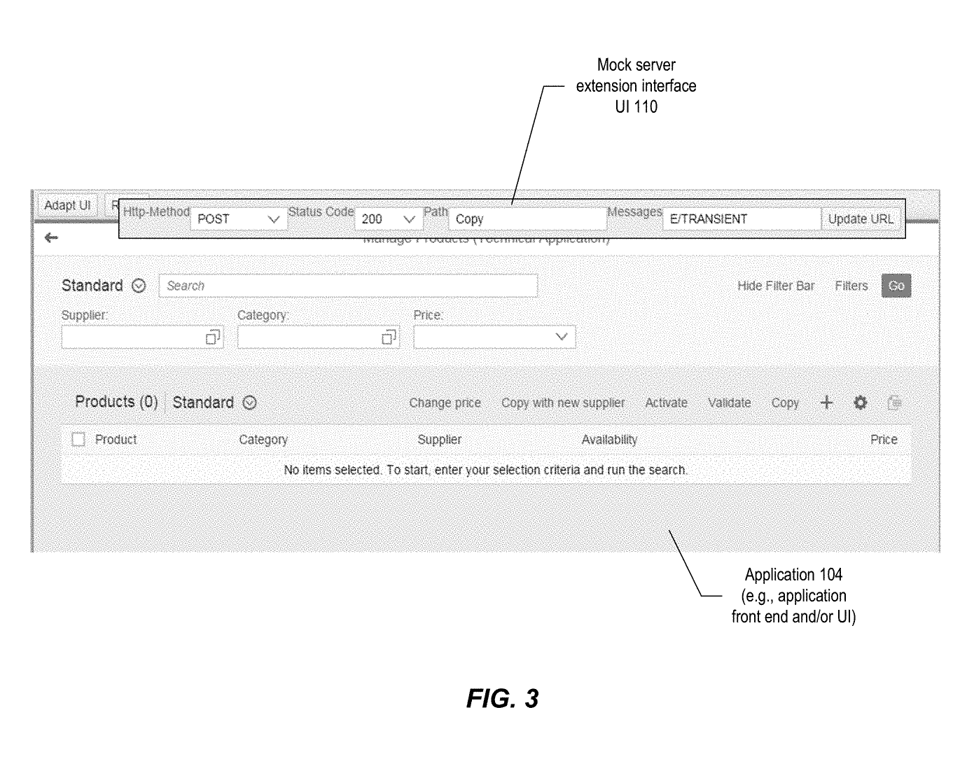

The system may include one or more applications 104 that execute on the client device(s) 100. In some instances, the application(s) 104 may execute at least partly in a browser. The browser may be configured to present web content described using a version of HyperText Markup Language (HTML), Extensible Markup Language (XML), JavaScript™, and/or other suitable programming languages or description formats. The browser may be a web browser and/or any other suitable container for the presentation of web content, such as a WebView and/or UIWebView object included in an application. Implementations also support the testing of native application(s) 104 that execute outside a web browser. The system may also include one or more mock server extension interfaces 106, such as an API 108 (e.g., a JavaScript™ API) and/or a UI 110. The UI 110 is described further with reference to FIG. 3.

The system may include an OData exchange 112. The OData exchange 112 may include one or more JavaScript Object Notation (JSON) files 114 that each includes one or more Uniform Resource Identifiers (URIs) and/or URI patterns (e.g., regular expressions). A URI may be a Uniform Resource Name (URN), a Uniform Resource Locator (URL), and/or any other format of a path, address, or other network location. The JSON file(s) 114 may be accessed by a mock server 116 included in the OData exchange 112. The mock server 116 may access a model 118. The model 118 may be a UI model, such as the OpenUI5 model.

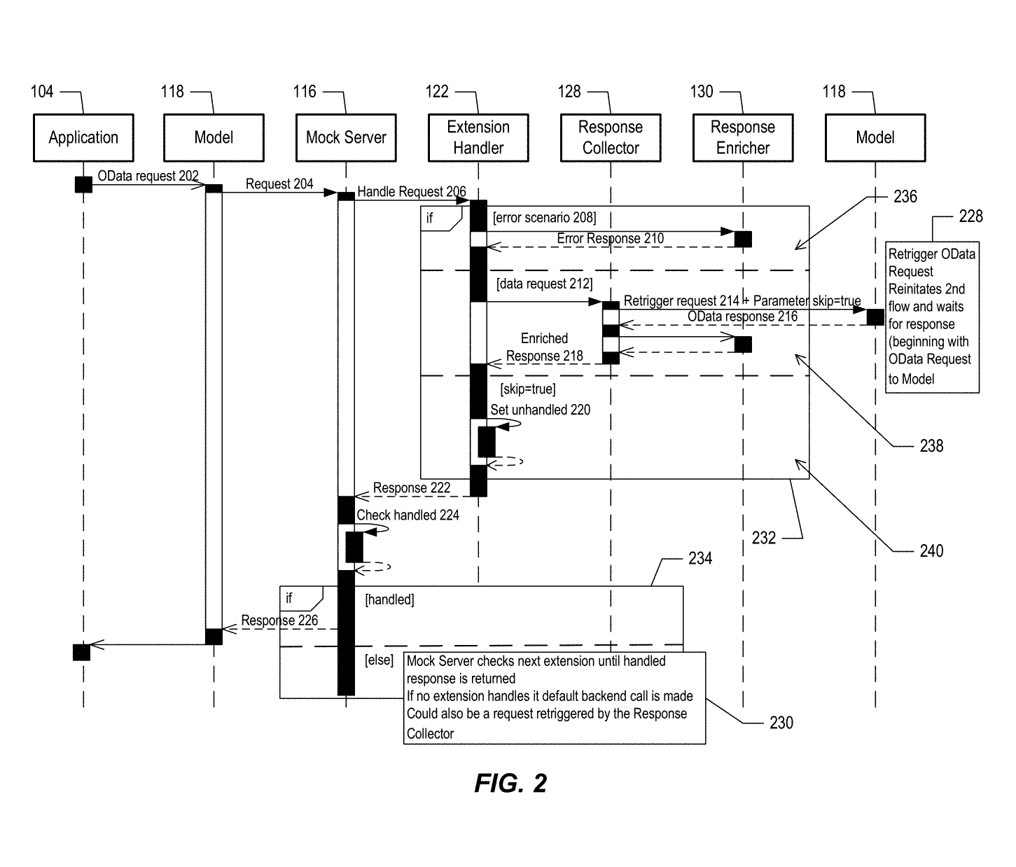

The OData exchange 112 may include a mock server extension 120, which may include an extension handler 122, a pattern and/or response template store 124, a response manager 126, a response collector 128, and/or a response enricher 130. The operations of these components are described further below and with reference to FIG. 2.

The system may also include a backend and/or gateway, referred to herein as backend 132. The backend 132 may include any suitable number and/or type of computing devices, such as backend server devices, distributed computing devices (e.g., cloud servers), application server devices, web server devices, data server devices, data storage devices, and so forth. The backend 132 may also include any suitable number and type of software modules executing on the backend device(s). The backend 132 may provide any number of OData service(s) 134 that process OData requests from the application(s) 104.

The mock server 116 may intercept a request sent from the application 104, and forward the request to the extension handler 122. Interception may also be performed by other types of interception mechanisms that intercept HTTP messages or other types of requests. Interception may include monitoring outgoing messages, receiving at least some of the outgoing messages (e.g., that exhibit particular characteristics), and preventing the message(s) from being communicated to their originally intended destination(s). In some implementations, the extension handler 122 determines whether a particular request is to be processed by the mock server 116 and mock server extension 120, or whether the request is to be sent on to the backend 132. If the determination is to handle a request at the mock server 116 and mock server extension 120, the extension handler 122 may determine whether there is a corresponding pattern and/or response template present in the pattern and/or response template store 124. The response template may indicate the information to be included in the mock response. The response template may also indicate error messages to be included in the mock response. If the extension handler 122 finds an appropriate response template, the extension handler 122 may call the response enricher 130. The response enricher 130 may define error scenarios to be incorporated into the baseline response body. The enriched mock response may be provided to the mock server 116, which may return the mock response to the application 104, e.g., without interaction with the backend 132.

In some implementations, the response enricher 130 and the response collector 128 may be employed to determine the mock response. The mock server 116 may intercept a request and provide the request to the extension handler 122, and the extension handler 122 may determine whether to handle the request as described above. In some instances, the response template may indicate a warning message and/or success message to include in the mock response. The response collector 128 may initiate the process of sending the request to the backend 132, with a skip flag set to indicate that the extension handler 122 should be skipped in the next call.

In some scenarios, the mock server 116 may be called twice and the skip flag may be set to handle such situations. For example, the first call may be processed by the extension handler 122. The extension handler 122 may detect a certain URI and/or URI pattern for a request which requires an enriched response (e.g., to add a warning and/or success message). The extension handler 122 may trigger a second request to the mock server 116 with the skip flag set to true (e.g., the skip flag may be used only by the extension handler). The extension handler 122 may then wait for the response to the second request. While the first call is waiting the mock server 116 may process the second request and call the extension handler which skips the processing based on the skip flag and passes control back to the mock server 116. The mock server 116 may then perform the ordinary processing to either provide a mocked response or call the actual backend. The response is then received from the first call which has been waiting for the response of the second call. The mock server 116 may then take the response to the first call, enrich it, and return it to the application. Accordingly, the skip flag may be used to indicate that the mock server is to do its normal job in the second call and to enrich the response to the first (e.g., waiting) call.

The response collector 128 may trigger another OData call to the model 118, and the call may go to the mock server 116 from the model 118. The mock server 116 may call the extension handler 122 with an indicator that this request has been flagged as a request which is to be handled by normal processing with a call to the backend 132 (e.g., skipping the extension handler 122 processing). After the request is processed and the corresponding response is received from a JSON file 114, from the mock server 116 (e.g., if it generated data), and/or from the backend 132, the response is provided to the response enricher 130. The response enricher 130 may add an additional HTTP header, warning message, success message, and/or other content to the mock response, which may then be passed to the application 104. In this way, implementations may employ the extension handler 122 to add additional content (e.g., warnings, success messages, etc.) to a response that is generated by the mock server 116 and/or the backend 132.

In some instances, if it is determined to enrich a positive response (e.g., success message, happy path request, etc.), the above process may be iterated. For example, a request may be retriggered and the system may wait for the response from the backend 132 and/or mock server 116. The response may be enriched by the response enricher 130 and passed to the application 104. In this way, the mock server 116 may initially determine the mock response based on information in the JSON file(s) 114, and the response may be enriched afterwards prior to be sent to the application 104.

In some implementations, the response manager 126 registers URI patterns that are to be intercepted and maintains the response templates 124. In some instances, the response manager 126 may not be invoked during the request processing. The response manager 126 may interact with the API 108 and/or the UI 110, and may be configured to operate as a design time agent to register URIs and/or URI patterns and to maintain the corresponding response templates 124.

FIG. 2 depicts a flow diagram of an example process for using a mock server 116 to test an application 104, according to implementations of the present disclosure. Operations of the process may be performed by one or more of the application(s) 104, the mock server extension interface(s) 106, the API 108, the UI 110, the OData exchange 112, the mock server 116, the model 118, the extension handler 122, the response manager 126, the response collector 128, the response enricher 130, the OData service(s) 134, and/or other software module(s) executing on the client device(s) 100, the backend 132, and/or elsewhere.

The application 104 may generate a request 202, such as an OData request. In instances where the application 104 employs the model 118 for data processing, the request 202 may be received by the model 118. The model 118 may generate a request 204 based on the OData request 202, and the request 204 may be received by the mock server 116. As described above, the mock server 116 may intercept the request 204 and send it on to the extension handler 122 with a request 206 that the extension handler 122 determine whether and/or how to handle the request.

In some implementations, the request 204 and/or handle request 206 may originate with a browser in which the application 104 is executed. The request 204 may be triggered by the model 118 asynchronously. During this request 204, the handle request 206 may be triggered synchronously, e.g., in the request handle method. The first asynchronous request 204 may be on hold and the caller (e.g., the model 118) may wait for its result. The second request may be triggered by the extension the model and the application that is built with the model 118 may not be aware of the second request, e.g., the application may wait for the first request and receive the result from the first request. If there are no mocked data, a backend request may be triggered. In such instances, the second request may perform the backend request, and the first request may forward the result of the second request

In some implementations, the extension handler 122 may determine whether or not to handle the request based on a path (e.g., URI, URI pattern, and/or regular expression) provided through the UI 110 and/or API 108. For example, if the request corresponds to the path, the request may be handled by the mock server 116 and extension 120. In such instances, the message(s), status code, and/or other information in provided to the UI 110 and/or API 108 may be used to generate the mock response. If the request does not correspond to the path provided by the UI 110 and/or API 108, the mock server 116 may access the JSON file(s) 114 and determine whether any of the information in the JSON file(s) 114 corresponds to the request. In some examples, the mock server 116 may generate dummy data in addition to or instead of accessing the JSON file(s) 114, and the dummy data may at least partly take the place of the data that would otherwise be provided in the JSON file(s) 114. If so, the mock server 116 may use the information from the JSON file(s) 114 to generate the mock request. If the request does not correspond to the path or the JSON information, the mock server 116 may send the request to the backend 132 for (e.g., non-test) processing.

In some implementations, the store 124 that includes response templates and/or patterns (e.g., regular expressions) may be accessed, and the information stored therein may be used to determine whether the request is to be handled at the mock server 116 and/or extension 120, as described with reference to FIG. 1. In other words, the extension handler 122 may determine whether there is any handling of the request to be performed at the mock server 116 and/or extension 120 level, based on whether the store 124 includes a pattern and/or response template that corresponds to the request.

If the extension handler 122 determines to handle the request, a set of conditions are evaluated as indicated in the conditional block 232. In the conditional block 232, processing may proceed according to one of three possible scenarios 236, 238, or 240. In a first scenario 236, the error scenario 208, a mock response is to be generated that includes an error message and/or error condition. In this scenario, the extension handler 122 may pass the response to the response enricher 130. The response enricher 130 may incorporate the appropriate error message and/or other content into the error response 210 (e.g., mock response) and return the error response 210 to the extension handler 122. In some instances, the extension handler 122 may determine which of the three scenarios is appropriate, for a particular request, based at least partly on HTTP codes. For example, for a code of 4xx or 5xx the extension handler 122 may determine scenario 236 is appropriate, and the response may not include any additional information apart from error message(s) in the body of the response. For a code of 2xx, the scenario 238 may be appropriate and the response may include additional information (if available) that is included as message(s) in the header of the response.

The second scenario 238 is the scenario in which a warning message, success message, and/or other content is to be included in the mock response. In such scenarios, the extension handler 122 may send a data request 212 to the response collector 128. The response collector 128 may send a retrigger request 214 to the model 118 to request processing of the request to generate a response from the backend 132 and/or based on the JSON file(s) 114. As indicated in block 228, the retrigger request 214 may retrigger an OData request and/or reinitiate a second flow. The model may then wait for the OData response 216 and send the OData response 216 back to the response collector 128. The response collector 128 may provide the OData response 216 to the response enricher 130. The response enricher 130 may incorporate a warning message, success message, and/or other content into the OData response 216, and return the enriched response 218 to the response collector 128. The response collector 128 may then return the enriched response 218 to the extension handler 122. In this scenario, the response collector 128 may also set the skip parameter to equal true to indicate that the extension handler 122 is to skip further processing of the enriched response 218 after receiving it from the response collector 128.

In the third scenario 240, if the skip parameter has been set to true (e.g., in the second scenario described above), the extension handler 122 may set an unhandled flag 220 to true and not otherwise process the response. In each of the three scenarios, the extension handler 122 may return the response 222 to the mock server 116, such as one of the error response 210 or the enriched response 218.

In some implementations, the determination of which scenario to follow may be based at least partly on a status description (e.g., status code) set through the UI 110 and/or API 108. For example, if the status code is set to indicate a lack of authorization error (e.g., code 403), then the process may follow the first scenario and generate the error response 210 that includes no information in addition to the error code. If the mock response is to simulate a situation in which access was denied, including the requested data in the response would be inappropriate given that the “user” is unauthorized to receive such data in this test scenario. If the status code is set to indicate that a warning should be added to the response, e.g., a code 200, then the second scenario may be followed.

Enrichment of a response may include adding a warning message, a success message, and/or other content. In some implementations, enrichment may include modifying (e.g., tweaking) the response data to test various situations. Enrichment may include optimizing and/or otherwise modifying the response data to simulate situations which are related to the data but which may not be simulated in the backend 132. For example, the data may be modified to test a situation in which the actual response data received from the backend 132 is corrupted and/or incomplete in some way.

After the request is processed according to at least one of the three scenarios, the mock server 116 may check (at 224) whether the request was handled according to one of the first two scenarios. This checking may proceed as indicated in conditional block 234. If the request was handled according to one of the first two scenarios (e.g., if the unhandled flag is not set to true), the response 226 (e.g., mock response) may be returned to the model 118, which may then pass the response back to the application 104. If the unhandled flag is set to true, the process may proceed as described in block 230. The mock server 116 may repeat the request handling process and check the next extension until a handled response is returned. If no extension handles the request, then a default call may be made to backend 132. In some implementations, the request may be retriggered by the response collector 128 as described above.

The interactions between the mock server and the extension 120 components may be described as an API contract between the mock server 116 and the extension 120. In some examples, each extension component may indicate whether the request was handled by that component, such as the extension handler 122, the response collector 128, and/or the response enricher 130.

Although the example of FIG. 2 depicts the processing of a single request, implementations also support the processing of multiple requests serially and/or in parallel. In such instances, each request may be processed according to the operations of FIG. 2.

FIG. 3 depicts an example application 104 and UI 110 for testing the application 104 using a mock server 116, according to implementations of the present disclosure. In the example of FIG. 3, the UI 110 of the mock server extension interface 106 is presented as a UI bar near the top of the application UI. The UI 110 includes various data entry fields to enable a user (e.g., developer, tester, etc.) to submit information to indicate the mock response that is to be generated by the mock server 116 and sent to the application 104 after the mock server 116 intercepts the request that is sent toward the backend 132. Although FIG. 3 presents the UI 110 with a particular configuration and set of controls, implementations are not limited to this example. Implementations support a UI 110 that includes any suitable number, type, and/or arrangement of UI elements to facilitate the user's specification of the mock response. The UI 110 may be presented in response to the user indicating that a mock response is to be used instead of an actual response emitted by the backend 132. In some implementations, the UI 110 may be initially presented with a button or other control (e.g., “click to edit”), and the user may select the button or other control to indicate that the response is to be a mock response. In some examples, a developer may indicate that a response is to be mocked by registering a path which matches a certain URI, for example by entering in the Path field a regular expression for matching one or more URIs. A developer may input a particular HTTP-method such as HTTP GET which may also match the request(s). In the example of FIG. 3, the application 104 is an example inventory control application in which an end-user may view information regarding products, suppliers, prices, and so forth. Implementations support the testing of various types of application(s) 104, and are not limited to this example.

In the example of FIG. 3, the user has specified a type of request to be intercepted by the mock server 116 and responded to with a mock response. In some implementations, the mock server 116 examines the URI or other characteristics of the request and determines whether a mock response is to be generated. If the URI or other characteristics match a record indicating that a mock response is to be generated, the mock server 116 provides a mock response which is taken from a locally stored JSON file or other data structure. In such instances, the mock server 116 does not interact with the backend. In some implementations, the mock server 116 dynamically generates the mock response. In some implementations, the mock server 116 may retrieve the mock response from the JSON file and dynamically modify the mock response based on certain criteria.

In some implementations, the mock server 116 intercepts all requests sent from the application 104 and, based on the information provided through the UI 110 and/or API 108, the mock server 116 generates and/or retrieves mock response(s) and sends them to the application 104. For example, the user may indicate that sales orders submitted through the application 104 are to be intercepted and a warning message is to be sent back to the application 104 in addition to or instead of the response normally returned from the backend 132. In some examples, the UI 110 and/or API 108 may be employed to indicate that the mock server 116 is to not send any response(s) back to the application 104, or send a particular error message (e.g., the end-user lacks authorization for this request) in response to a sales order request. The UI 110 may include a data box for messages, and the data box may enable the user to specify additional messages that are to be included in the mock response(s) sent by the mock server 116. Accordingly, the mock server 116 may be employed simulate a variety of scenarios and thus enable the negative and/or positive testing of how the application 104 behaves based on messages exchanged between the application 104 and the backend 132. In some implementations, the UI 110 may be presented when the application 104 is being executed in a test mode or within a test environment, and may not be presented when the application 104 is running in production or otherwise facing an actual end-user who is not part of the development team.

In the example of FIG. 3, the UI 110 enables a user to specify an action which, when performed in the application UI, prompts the mock server 116 to instruct the extension 120 to generate a mock response which is then sent back to the application 104. Using the UI 110, the user may specify a particular path that is a URI and/or a pattern (e.g., regular expression) for a URI of the request. The user may indicate how the mock server 116 is to respond to requests that match the URI and/or pattern. The user may also specify the type of requests that are to be intercepted and responded to with a mock response. For example, the user may indicate a type of request such as a HTTP-method, e.g., HTTP GET, POST, PUT, and so forth. The user may also specify characteristic(s) of the request to be intercepted. For example, using the UI 110 the user may indicate that order requests (e.g., from an inventory application) are to be intercepted if the inventory identifier in the request starts with a particular sequence (e.g., 100), and the mock response should include an error message indicating that the current user is not authorized to submit such requests. This may enable both negative and positive testing to be performed in a same test session based on the inventory identifiers included in the particular requests that are sent from the application 104.

In some implementations, the UI 110 and/or API 108 may enable the specification of a status description such as a status code. The status description may be a return code that is to be included in the mock response sent by the mock server 116. For example, a code of 200 may indicate that the requested data is available at the location specified by the path, and that the data is retrievable and useable. As another example, a code of 400 or 500 may indicate that the requested data is not available and/or that a particular error condition is present, such as the backend server is unable to access the data, the requested data is not present in storage, the user in unauthorized to access the data, and so forth. In some instances, the mock server 116 may intercept the request and return a mock response that includes the status description (e.g., code) and no other information. In some instances, other information (e.g., messages, mock data, etc.) may be included in the mock response with the status description. The status description may indicate an error condition, a warning, or a success condition (e.g., lack of errors and/or warnings). In some implementations, the UI 110 may include a drop-down list or other control that enables a user to select a particular type of error and/or warning from a list of possibilities. In some implementations, each entry in the list may be a status code, as shown in the example of FIG. 3. The status code may apply to an overall (e.g., HTTP) request. In some instances, one status code may apply to a whole list as the list is retrieved in a single call. The warning and/or success format may reference multiple entries in the response, and this may also be mocked. In some implementations, each entry in the list may be a description of the type of error and/or warning (e.g., “file not found error”, “unauthorized user error”, and so forth), and the list entries may include and/or be associated with status codes. In some implementations, the UI 110 may include a control that enables a user to enter or select the status description as a (e.g., numeric) status code, as shown in the example of FIG. 3.

In some examples, the UI 110 may include a set of selectable buttons or other controls to enable a user to indicate whether the mock response is to be an error response, an enriched response with a warning message, and/or an enriched response with a success message. The user may then entire the desired message(s) and/or status code(s) through the UI 110 to provide the information to be included in the mock response.

In some implementations, the mock server 116 may send a mock response in response to request(s) that correspond to the specified path (e.g., URL and/or pattern). In some implementations, the mock server 116 may configured to generate a mock response with an error and/or warning in one or more randomly determined responses that are sent back to the application 104. Such a feature may provide an element of randomness to test the application 104 under various situations that may occur in a production execution environment. In such implementations, the UI 110 and/or API 108 may enable the specification of the proportion of mock responses to be randomly selected to include a particular error and/or warning. In some instances, such randomness may not be employed during regression testing to ensure that a previously identified problem has been fixed in the application 104.

In some implementations, for positive testing and/or negative testing the mock server 116 may employ a JSON file or other suitable data structure to determine how to respond to particular request(s) with mock response(s). The JSON file (or other data structure) may store a record indicating the information to include in a mock response based on the status code specified using the UI 110 and/or API 108. Accordingly, information provided through the extension interface 106 may be employed to determine the mock response to be returned to the application 104. The mock server 116 may process the request(s) consistently for the same specified status code. For example a particular request may be handled consistently but with additional processing when the status code is specified, to indicate that the extension information provided through the UI 110 and/or API 108 is to be incorporated into the mock response. Such additional processing based on a status code may be described as a special mode.

For example, the mock server 116 may be configured to operate in two modes. In both modes, the mock server 116 may intercept at least some or all of the requests sent from the application 104. In a first mode, the mock server 116 may respond to a particular request by sending the request on to the backend 132, e.g., in instances where the code indicates normal processing of the request. In the second mode, the mock server 116 may respond to a particular request by not sending the request to the backend 132 and instead determining a mock response which the mock server 116 sends back to the application 104. The mock response may be generated dynamically and/or retrieved from the JSON file (or other data structure) based on the information specified through the UI 110 and/or API 108. In some instances, the data read from the JSON file may be re-used so that it does not need to be re-generated for each mock response. In some instances, the mock server 116 may employ “real” response data, e.g., generated by the backend 132. In some instances, the mock server 116 may modify the “real” data prior to sending the mock response to the application 104.

In some implementations, the information specified through the UI 110 and/or API 108 may be stored in JSON file(s) and/or other data structures, and the mock server 116 may retrieve the information to process subsequent responses with similar characteristics. Accordingly, the information may not need to be re-specified each time a particular error and/or warning condition is to be generated. In some implementations, the information specified through the UI 110 and/or API 108 may be processed in active memory and not stored in persistent storage. The JSON file(s) and/or other data structures may also store the information regarding error and/or warning messages to be included in the mock response(s).

Implementations support various channels through which error and/or warning information may be specified, for use by the mock server 116 in determining mock response(s) to send to the application 104. As described above, the channels may include the extension interfaces 106 such as the API 108 and the UI 110. In some implementations, error and/or warning information may be hard-coded (e.g., programmed) into the system, or otherwise programmatically defined, for certain test cases. In some instances, one or more test cases may be programmatically defined to validate how the application UI reacts in particular situations. In at least some such instances, the programmatically specified test case(s) may not be combined with mock server extension information to generate the mock response(s) for testing the application 104.

For example, suppose a developer wants to test a large number M (e.g., 100) of different configurations for an application 104. The developer may create N number of JSON files that describe the various error conditions to be tested, and then create M variants of each JSON file for all the application configurations, for a total of M times N JSON files created. Such a task may be time consuming and difficult for large values of M and/or N. Alternatively, the developer may create the N number of JSON files, and programmatically the mock server 116 may be configured to create the M desired variants of the mock response(s) suitable to test the various configurations of the application 104 for each error condition to be tested. Implementations may also operate in a slightly different manner, by starting a test run based on a programmatically defined set of tests in which the return code is a 400 or a 404. A user may observer now the application 104 reacts to such conditions, and based on those observations define further tests using the UI 110 to indicate particular warning and/or error conditions.

In some implementations, the mock server 116 may determine whether to handle a particular request or route the request to the backend 132 based on whether the request corresponds to a record that is in the JSON file or other data structure used to make request routing decisions. For example, a JSON file may describe 50 different types of sales order requests for which mock responses are to be sent in response to the request. If the mock server 116 determines that a particular sales order request is described in the JSON file, the mock server 116 may employ the information in the JSON file (and/or information specified in the extension interface(s) 106) to generate the mock response to the sent to the application 104, without forwarding the request to the backend 132. If the particular sales order request is not described in the JSON file, the mock server 116 may forward the request to the backend 132, receive the response from the backend 132, and send the response on to the application 104. Such interception and handling of requests based on information in the JSON file may be employed in positive testing and/or negative testing.

Although examples herein may describe using a single JSON file that stores information for mock response generation, implementations may use any suitable number and/or type of data structures to store such information. In some implementations, the JSON file (or other data structure) may not store path information to determine which responses are to be mocked. The path information may be provided through the UI 110 and/or API 108. In such implementations, the JSON file (or other data structure) may store information to be included in the mock response(s) to various request(s), and the mock server 116 may map a path (e.g., URL and/or regular expression pattern) to particular information in a particular JSON file. In some implementations, the JSON file (or other data structure) may be OData compliant.

In some implementations, separate JSON files may each describe one or more mock responses to be sent to the application 104. For example, for testing orders 1, 2, and 3, the mock response information may be stored in one JSON file chain. For testing order 9, the information may be stored in a separate JSON file. The information for generating the mock response(s) may be stored in the JSON file. Alternatively, in some implementations the JSON file may indicate that the mock server 116 is to dynamically generate information to include in the mock response(s). In some instances, the JSON file may indicate that the mock server 116 is to generate random and/or nonsensical information to include in the mock response(s).

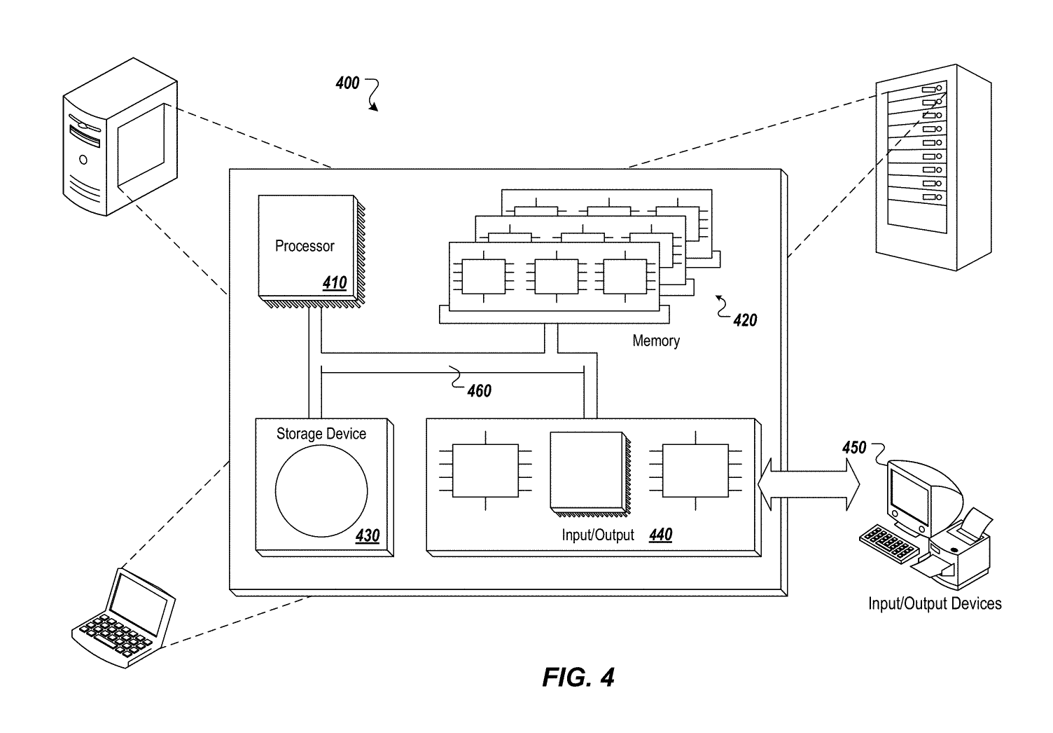

FIG. 4 depicts an example computing system, according to implementations of the present disclosure. The system 400 may be used for any of the operations described with respect to the various implementations discussed herein. For example, the system 400 may be included, at least in part, in one or more of the client device(s) 100, the backend 132, and/or other computing device(s) described herein. The system 400 may include one or more processors 410, a memory 420, one or more storage devices 430, and one or more input/output (I/O) devices 450 controllable through one or more I/O interfaces 440. The various components 510, 520, 530, 540, or 550 may be interconnected through at least one system bus 460, which may enable the transfer of data between the various modules and components of the system 400.

The processor(s) 410 may be configured to process instructions for execution within the system 400. The processor(s) 410 may include single-threaded processor(s), multi-threaded processor(s), or both. The processor(s) 410 may be configured to process instructions stored in the memory 420 or on the storage device(s) 430. The processor(s) 410 may include hardware-based processor(s) each including one or more cores. The processor(s) 410 may include general purpose processor(s), special purpose processor(s), or both.

The memory 420 may store information within the system 400. In some implementations, the memory 420 includes one or more computer-readable media. The memory 420 may include any number of volatile memory units, any number of non-volatile memory units, or both volatile and non-volatile memory units. The memory 420 may include read-only memory, random access memory, or both. In some examples, the memory 420 may be employed as active or physical memory by one or more executing software modules.

The storage device(s) 430 may be configured to provide (e.g., persistent) mass storage for the system 400. In some implementations, the storage device(s) 430 may include one or more computer-readable media. For example, the storage device(s) 430 may include a floppy disk device, a hard disk device, an optical disk device, or a tape device. The storage device(s) 430 may include read-only memory, random access memory, or both. The storage device(s) 430 may include one or more of an internal hard drive, an external hard drive, or a removable drive.

One or both of the memory 420 or the storage device(s) 430 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 400. In some implementations, the CRSM may include a data store that provides storage of computer-readable instructions or other information in a non-transitory format. The CRSM may be incorporated into the system 400 or may be external with respect to the system 400. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) 410 and the memory 420 may be supplemented by, or incorporated into, one or more application-specific integrated circuits (ASICs).

The system 400 may include one or more I/O devices 450. The I/O device(s) 450 may include one or more input devices such as a keyboard, a mouse, a pen, a game controller, a touch input device, an audio input device (e.g., a microphone), a gestural input device, a haptic input device, an image or video capture device (e.g., a camera), or other devices. In some examples, the I/O device(s) 450 may also include one or more output devices such as a display, LED(s), an audio output device (e.g., a speaker), a printer, a haptic output device, and so forth. The I/O device(s) 450 may be physically incorporated in one or more computing devices of the system 400, or may be external with respect to one or more computing devices of the system 400.

The system 400 may include one or more I/O interfaces 440 to enable components or modules of the system 400 to control, interface with, or otherwise communicate with the I/O device(s) 450. The I/O interface(s) 440 may enable information to be transferred in or out of the system 400, or between components of the system 400, through serial communication, parallel communication, or other types of communication. For example, the I/O interface(s) 440 may comply with a version of the RS-232 standard for serial ports, or with a version of the IEEE 1284 standard for parallel ports. As another example, the I/O interface(s) 440 may be configured to provide a connection over Universal Serial Bus (USB) or Ethernet. In some examples, the I/O interface(s) 440 may be configured to provide a serial connection that is compliant with a version of the IEEE 1394 standard.

The I/O interface(s) 440 may also include one or more network interfaces that enable communications between computing devices in the system 400, or between the system 400 and other network-connected computing systems. The network interface(s) may include one or more network interface controllers (NICs) or other types of transceiver devices configured to send and receive communications over one or more networks using any network protocol.

Computing devices of the system 400 may communicate with one another, or with other computing devices, using one or more networks. Such networks may include public networks such as the internet, private networks such as an institutional or personal intranet, or any combination of private and public networks. The networks may include any type of wired or wireless network, including but not limited to local area networks (LANs), wide area networks (WANs), wireless WANs (WWANs), wireless LANs (WLANs), mobile communications networks (e.g., 3G, 4G, Edge, etc.), and so forth. In some implementations, the communications between computing devices may be encrypted or otherwise secured. For example, communications may employ one or more public or private cryptographic keys, ciphers, digital certificates, or other credentials supported by a security protocol, such as any version of the Secure Sockets Layer (SSL) or the Transport Layer Security (TLS) protocol.

The system 400 may include any number of computing devices of any type. The computing device(s) may include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. Although examples herein may describe computing device(s) as physical device(s), implementations are not so limited. In some examples, a computing device may include one or more of a virtual computing environment, a hypervisor, an emulation, or a virtual machine executing on one or more physical computing devices. In some examples, two or more computing devices may include a cluster, cloud, farm, or other grouping of multiple devices that coordinate operations to provide load balancing, failover support, parallel processing capabilities, shared storage resources, shared networking capabilities, or other aspects.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor may receive instructions and data from a read only memory or a random access memory or both. Elements of a computer can include a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be realized on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be realized in a computing system that includes a back end component, e.g., as a data server, or that includes a middleware component, e.g., an application server, or that includes a front end component, e.g., a client computer having a graphical UI or a web browser through which a user may interact with an implementation, or any appropriate combination of one or more such back end, middleware, or front end components. The components of the system may be interconnected by any appropriate form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method performed by at least one processor, the method comprising:
intercepting, by the at least one processor, a request sent from an application toward a backend device, the application employing a user interface (UI) model to provide one or more UI elements;
determining, by the at least one processor, a mock response to the request, the mock response including at least one of an error message or a warning message; and
providing, by the at least one processor, the mock response to the application during negative testing to monitor behavior of the application receiving the mock response.

2. The method of claim 1, wherein determining the mock response further comprises:
determining a status description for the request; and
based at least partly on the status description, including the error message or the warning message in the mock response.

3. The method of claim 2, wherein:
the status description is provided through one or more mock server extension interfaces that include one or more of an application programming interface (API) or a UI presented with the application.

4. The method of claim 2, further comprising:
based at least partly on the status description, retriggering the request to cause a response to be generated and sent by the UI model; and
incorporating the warning message into the response to generate the mock response.

5. The method of claim 1, wherein determining the mock response further comprises:
determining that the request corresponds to information stored in a file and, in response, generating the mock response to include the information in the file.

6. The method of claim 5, wherein the file is a JavaScript Object Notation (JSON) file.

7. The method of claim 5, wherein the information includes at least one of a Uniform Resource Identifier (URI) or a URI pattern matching a URI included in the request.

8. The method of claim 1, wherein the request is an OData request.

9. A system, comprising:
at least one processor; and
a memory communicatively coupled to the at least one processor, the memory storing instructions which, when executed by the at least one processor, cause the at least one processor to perform operations comprising:
intercepting a request sent from an application toward a backend device, the application employing a user interface (UI) model to provide one or more UI elements;
determining a mock response to the request, the mock response including at least one of an error message or a warning message; and
providing the mock response to the application during negative testing to monitor behavior of the application receiving the mock response.

10. The system of claim 9, wherein determining the mock response further comprises:
determining a status description for the request; and
based at least partly on the status description, including the error message or the warning message in the mock response.

11. The system of claim 10, wherein:
the status description is provided through one or more mock server extension interfaces that include one or more of an application programming interface (API) or a UI presented with the application.

12. The system of claim 10, the operations further comprising:
based at least partly on the status description, retriggering the request to cause a response to be generated and sent by the UI model; and
incorporating the warning message into the response to generate the mock response.

13. The system of claim 9, wherein determining the mock response further comprises:
determining that the request corresponds to information stored in a file and, in response, generating the mock response to include the information in the file.

14. The system of claim 13, wherein the file is a JavaScript Object Notation (JSON) file.

15. One or more computer-readable media storing instructions which, when executed by at least one processor, cause the at least one processor to perform operations comprising:
intercepting a request sent from an application toward a backend device, the application employing a user interface (UI) model to provide one or more UI elements;
determining a mock response to the request, the mock response including at least one of an error message or a warning message; and
providing the mock response to the application during negative testing to monitor behavior of the application receiving the mock response.

16. The one or more computer-readable media of claim 15, wherein determining the mock response further comprises:
determining a status description for the request; and
based at least partly on the status description, including the error message or the warning message in the mock response.

17. The one or more computer-readable media of claim 16, the operations further comprising:
based at least partly on the status description, retriggering the request to cause a response to be generated and sent by the UI model; and
incorporating the warning message into the response to generate the mock response.

18. The one or more computer-readable media of claim 15, wherein determining the mock response further comprises:
determining that the request corresponds to information stored in a file and, in response, generating the mock response to include the information in the file.

19. The one or more computer-readable media of claim 18, wherein the information includes at least one of a Uniform Resource Identifier (URI) or a URI pattern matching a URI included in the request.

20. The one or more computer-readable media of claim 15, wherein the request is an OData request.
